(19) United States
(12) Patent Application Publication
(10) Pub. No.: US 2003/0219086 A1
(43) Pub. Date: Nov. 27, 2003

(54) Jitter identification using a wide bandwidth oscilloscope

(76) Inventors: Greg D. LeCheminant, Santa Rosa, CA (US); Jady Palko, Windsor, CA (US); Bernhard M. Hovden, Sebastopol, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/152,931

(22) Filed: May 21, 2002

(51) Int. Cl. H04L 7/00

(52) U.S. Cl. 375/355

(57) ABSTRACT

Jitter identification and analysis may be performed using an oscilloscope or another widely used waveform-display device. A signal of interest, such as a clock signal or a data signal, is repeatedly sampled at a target phase position that is based upon the frequency of the signal of interest. Thus, the samples will be taken from the same phase point of successive cycles of the signal, if the signal is precisely maintained at the target frequency. However, any jitter within the signal will cause the sampling to occur at different phase points. As a consequence, a display of the sequence of samples generates a waveform having characteristics that correspond to the consistent characteristics of the jitter.

### TECHNICAL FIELD

The invention relates generally to identifying jitter within a signal and more particularly to the analysis of jitter using commonly available equipment.

### BACKGROUND ART

As the speeds of communication systems increase, the adverse effects of jitter on the performance of a system also increase. The term “jitter” is defined herein as “deviation of the significant instants of a signal from their ideal position in time.” Thus, jitter within a clock signal or a data signal will cause phase variations from the ideal. As examples, the “significant instants” of a clock signal may be the rising edge of each pulse or may be the center of the clock cycle.

In a communication system, information is encoded in accordance with transmit clock cycles. The bits of information are transmitted to a receiver, which samples the signal on the basis of the transmit clock cycle. Typically, the sampling is intended to occur at the center of each clock cycle, since this timing maximizes the likelihood that logic ones and zeroes will be accurately read. However, as jitter displaces the significant instants, the likelihood of error increases.

There are a number of sources of jitter. Jitter is caused by factors that include instabilities in the source of the clock cycles, external interference from power connections, and poor performance by one or more electronic component, such as an amplifier or a buffer. Jitter may be sinusoidal, i.e., the jitter may consist of regular sinusoidal variations that have a fixed frequency. U.S. Pat. No. 4,514,855 to Lang et al. describes a method of reducing sinusoidal components of phase jitter in a communication channel. Frequency correction is provided by comparing phase jitter with the output of a controlled oscillator, with the results of the comparison being used to alter a received signal.

Devices for measuring jitter are commercially available. One such jitter measuring device is sold by Agilent Technologies, Inc. under the component number 71501. The measures of jitter may be expressed in Unit Intervals (UI). A Unit Interval is one clock period. The expression of jitter in UI is typically in decimal fractions. As an alternative, the magnitude of jitter may be expressed in units of degrees, where one cycle equals 360 degrees. Jitter may also be expressed in terms of time, such as picoseconds. As an example, if the clock rate is 150 MHz, the clock period is 60 nanoseconds, which is equal to 360 degrees. Assuming a jitter of 100 picoseconds, peak-to-peak (pp), the jitter may be expressed as 0.15 UIpp, or as 5.4 pp degrees, or as100 ppps.

While the commercially available systems for measuring jitter operate well for their intended purposes, there are drawbacks. For example, the necessary equipment is not always available. Therefore, what is needed is a more readily available method and system for identifying jitter within a signal.

### SUMMARY OF THE INVENTION

Jitter is identified and jitter analysis is enabled by using a readily available waveform-generating device, such as an oscilloscope, to repeatedly sample a signal of interest and to display the sequence of samples as a representation of the jitter within the signal. The timing of the sampling event relative to the trigger event is adjusted so that the sampling will repeatedly occur at a specific phase point of the signal of interest, if that signal is jitter-free. Thus, the timing is established to generate samples at a target phase point of successive cycles of the signal, if the signal is precisely maintained at the target frequency. However, any jitter within the signal will cause the sampling to occur at off-target phase points. As a consequence, the display of the sequence of samples is a waveform having characteristics that correspond to characteristics of the jitter.

The displayed waveform is generated as a function of the phase deviation in the signal being analyzed. The waveform allows the level of jitter in the signal to be quantified. For example, the level of jitter may be calculated as a total of the degrees of phase deviation between two corresponding waveform instants. The corresponding instants may be successive phase reversal extremes along the jitter waveform. A starting point of “no phase deviation” is a midpoint between the two successive phase reversal extremes. The calculation of degrees is the sum of the degrees of deviation between the first phase reversal extreme and the starting point and the degrees of phase deviation between the starting point and the second phase reversal extreme.

The system of identifying the signal jitter includes the source of the signal and the oscilloscope. The source is intended to generate a signal having a particular frequency pattern. The frequency pattern is predictable, so that the generated and displayed jitter waveform has intelligible visual information. Typically, the frequency pattern is a fixed frequency, such as a clock frequency. The input of the oscilloscope is connected to the source to receive the signal. The oscilloscope is set to generate and display the jitter waveform, which is indicative of the phase deviations of the signal as compared to a signal that precisely maintains the desired frequency pattern.

The invention is well suited for monitoring sinusoidal jitter. One advantage of the invention is that the process and system may be carried out using equipment that is standard to laboratories. Oscilloscopes can be used to monitor a wide range of frequencies, such as those reaching 50 GHz. The system and method provide a wide jitter bandwidth capability. In addition to being used to analyze jitter within clock signals, the invention is applicable to data signals.

### BRIEF DESCRIPTION OF THE DRAWINGS

FIG. 1 is a front view of an oscilloscope having a screen display of samples acquired in measuring timebase linearity of the oscilloscope.

FIG. 2 is a representation of the phase deviation that may occur in a signal of interest, such as a clock signal.

FIG. 3 is a perspective view of a jitter identification system in accordance with the invention.

FIG. 4 is a front view of the screen of the oscilloscope of FIG. 3, showing 0.25 Unit Interval peak-to-peak (UIpp) jitter on a 500 MHz signal at a 500 KHz rate.

FIG. 5 is a screen view of an oscilloscope showing 0.5 UIpp jitter.

FIG. 6 is a representation of the phase deviation path along a 500 MHz signal for 1 UI of jitter.

FIG. 7 is a representation of a displayed signal for 1 UI of jitter.

FIG. 8 is a screen view of an oscilloscope having a displayed waveform of 1.0 UIpp, in accordance with the invention.

FIG. 9 is a screen display of an oscilloscope showing 1.5 UIpp in accordance with the invention.

FIG. 10 is a screen display of an oscilloscope showing 1.25 UIpp in accordance with the invention.

FIG. 11 is a screen display of an oscilloscope showing 1.75 UIpp in accordance with the invention.

FIG. 12 is a screen display of an oscilloscope showing 2.0 UIpp in accordance with the invention.

FIG. 13 is a screen display of an oscilloscope showing the 1.75 UIpp jitter level of FIG. 11, but with markers that indicate the phase reversal extremes of the displayed jitter waveform.

FIG. 14 is a front view of the oscilloscope display of FIG. 10, but with indicators of significant instants.

### DETAILED DESCRIPTION

The jitter-analysis approach that will be described below has an underlying framework that is related to a n approach which may be used for measuring the timebase linearity of a wide-bandwidth oscilloscope. Timebase linearity is a measure of the time precision of the oscilloscope, versus the actual position in time. If there is a degree of time position error in the sampling process performed by the oscilloscope, it is beneficial to quantify the error. The timebase linearity measure is the quantification of the time position error.

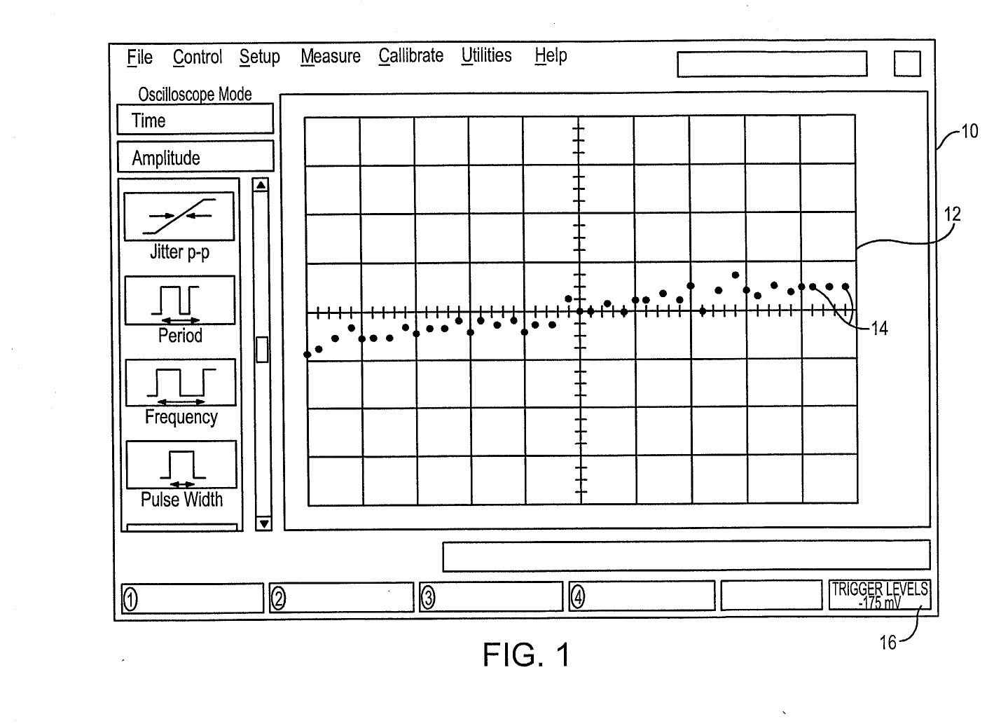

In order to better understand the present invention, the timebase linearity process will be briefly described. Specific values, such as the frequency of the input signal and the number of acquired samples, will be identified, but other values may be substituted. As a first step, a 10 GHz signal is used as an input to an oscilloscope being tested. The oscilloscope is configured to acquire forty samples across its screen. FIG. 1 shows a front view of an oscilloscope 10 having a display screen 12 with forty samples 14. The oscilloscope is adjusted to 400 picoseconds per division (4 nanoseconds full screen). Consequently, the oscilloscope displays samples 14 that are spaced every 100 picoseconds (ps). If the timebase of the oscilloscope is perfect, the samples should be taken at exactly the same relative phase point on the 10 GHz signal. That is, if the signal is a pure 10 GHz signal and the triggering signal is highly coherent to the 10 GHz signal, the samples should all be taken at the same phase point +/−n*360 degrees. If this is the case, all forty samples would have the same amplitude and the oscilloscope would show a flat line of the forty points.

In the ideal situation of the forty samples 14 having the same amplitude, adjustment of the trigger level 16 causes the precise time of sampling to vary slightly relative to the trigger event. This is manifested on the display screen 12 of the oscilloscope 10 as a movement of the “flat line” up or down in amplitude within the peak amplitude range of the clock signal. However, the oscilloscope 10 is less than perfect, so that samples are taken slightly off the ideal time point. Consequently, the time/phase locations of the samples deviate from the ideal in FIG. 1. Knowing the amplitude and period of the 10 GHz signal, a simple arcsine function yields the time deviation from the ideal. The deviation must be less than what would cause a cycle time error of 25 percent (i.e., plus or minus 90 degrees phase shift) to be unambiguous.

As previously noted, “jitter” is defined as deviation of the significant instants of a signal from the ideal position of those instants in time. It follows that the timebase linearity test has some relationship to a jitter identification technique. If the oscilloscope 10 is assumed to have only a very small timing error (i.e., a nearly flat line in the linearity test), then as the signal deviates from its ideal position in time (jitter), there will be a deviation from the flat line.

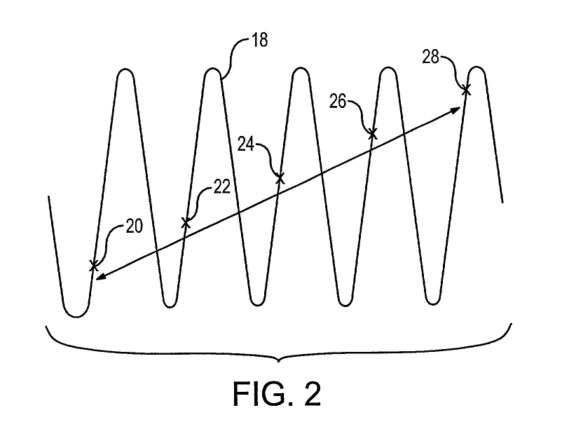

If both the oscilloscope time interval accuracy and the period of the signal are perfect, samples will be taken at the same relative phase point of the signal. On the other hand, phase modulation of the signal will cause inconsistencies in the signal period and the samples will be taken at varying phase locations. For example, if the rate of phase change is increasing as a result of increasing frequency, samples will be taken at subsequently later and later phase points. It follows that if the phase change is decreasing as frequency decreases, the samples will be taken at earlier and earlier phase points. Referring to FIG. 2, five cycles of a sinusoidal signal 18 are shown as being sampled at later and later phase points 20, 22, 24, 26 and 28. This would occur if the signal had 0.25 Unit Intervals peak-to-peak (UIpp) of jitter, so that the signal 18 would deviate 45 degrees from its nominal position. If the five samples are displayed on an oscilloscope, the resulting jitter waveform would have a period that matches the jitter rate and would have a peak-to-peak magnitude of arcsine π/4 multiplied by the peak-to-peak amplitude of the sampled signal 18.

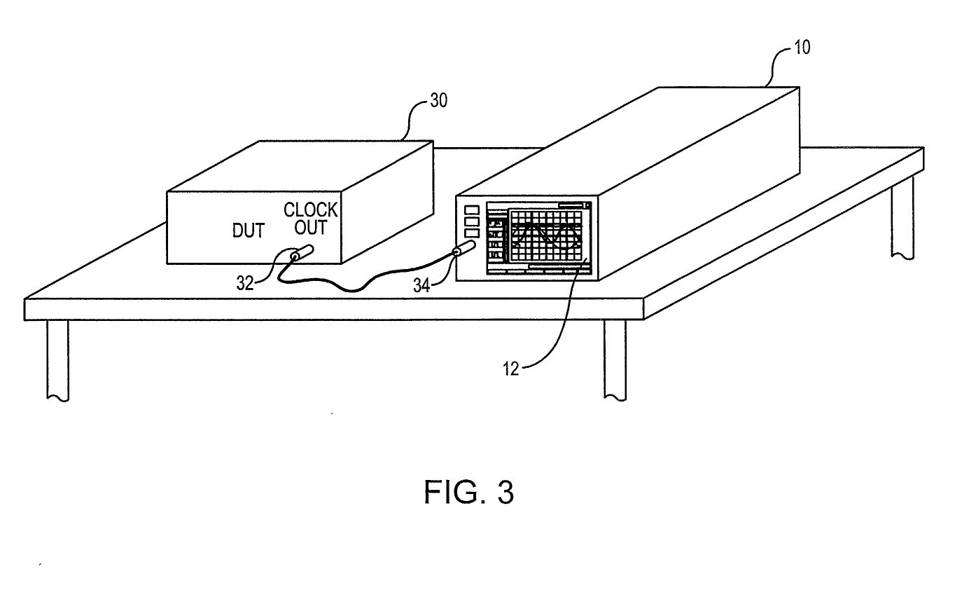

Referring now to FIG. 3, the jitter identification approach was tested for a device under test (DUT) 30. In actuality, the DUT 30 represents a source of a sinusoidal clock signal, a source of a jitter signal for phase modulating the clock signal, and a jitter analysis system that provides a comparison for the jitter quantification process that will be described.

The unmodulated source signal of the DUT 30 was set for 500 MHz. The modulating signal was set at 500 KHz. Given these frequencies, the oscilloscope 10 was set up to have 1000 points per trace and the time span of the oscilloscope was set to display more than one period of jitter signal. In the testing, the sync out of the source of the 500 KHz sinusoidal jitter signal was used to trigger the oscilloscope 10. Of course, the clock out 32 of the DUT 30 was used as an input 34 of the oscilloscope 10. In this particular arrangement, the jitter frequency must be harmonically related to the clock rate in order to be used as a valid trigger for the oscilloscope during measurement of the modulated clock signal.

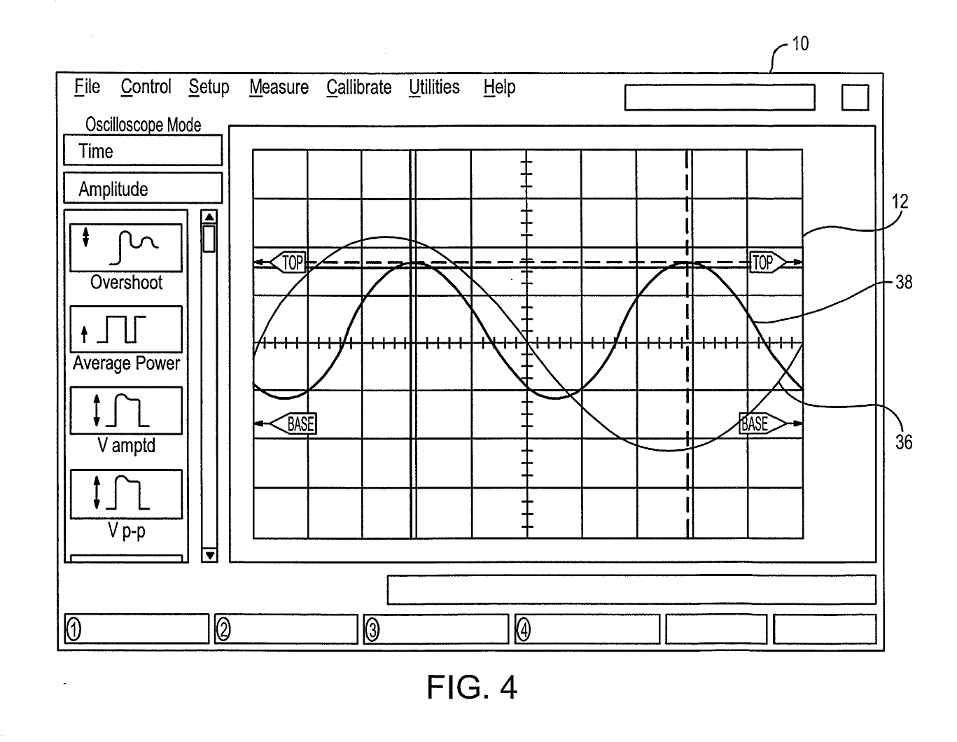

In a first arrangement, the jitter deviation was set to 0.25 UIpp (i.e., 90 degrees pp or 45 degrees peak deviation). In FIG. 4, a cycle of the 500 MHz clock signal is shown as the thinner trace 36 along the oscilloscope display screen 12. The thicker trace 38 is the extracted jitter. It should be noted that the clock trace 36 is shown for amplitude information only. The clock trace is acquired at a different timebase than the timebase for displaying jitter. The acquired clock trace data is stored and then displayed with the jitter signal, with the oscilloscope 10 being configured to correctly display the jitter. As expected, the period of the jitter signal was 2 microseconds (1/500 KHz). The amplitude of the jitter signal would be expected to be approximately 70 percent (arcsine 45) of the peak-to-peak amplitude of the 500 MHz signal. In actuality, the amplitude of the jitter signal trace 38 was approximately 149 mV, while the clock signal trace 37 was at 229 mV. This ratio is approximately 0.65, which equates to 41 degrees or 0.23 UIpp. This is in satisfactory agreement with the known 0.25 UIpp.

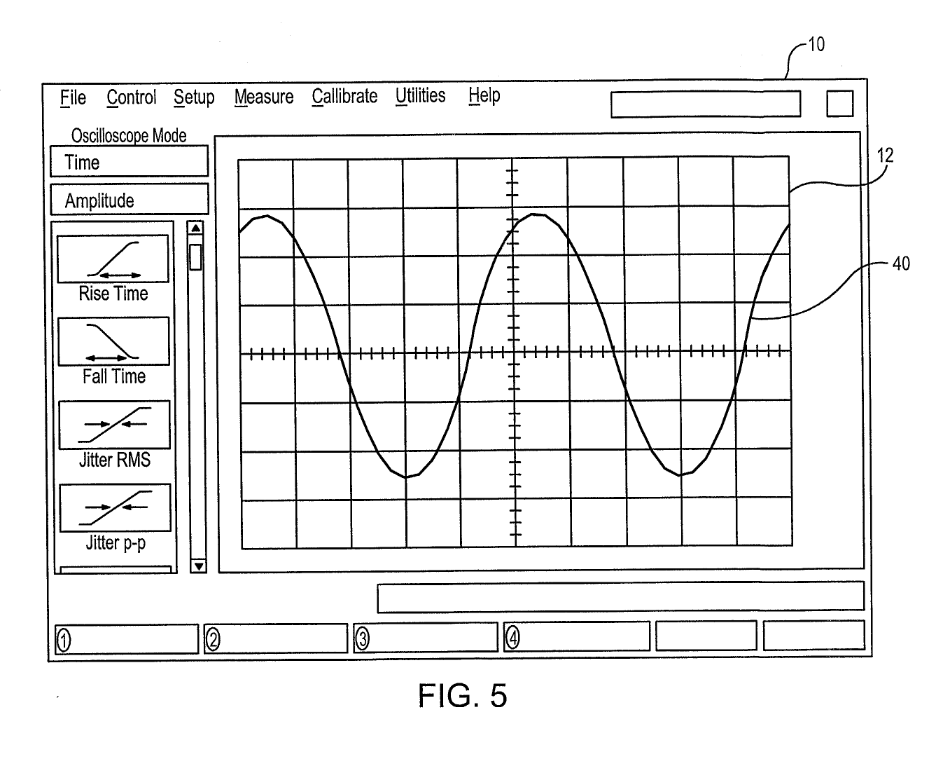

FIG. 5 shows a jitter signal trace 40 that is displayed when the jitter deviation is increased to 0.5 UIpp. At this level of jitter, it should be expected that the signal should move a full 90 degrees to either side of the zero crossing. As can be seen in FIG. 5, this indeed occurs.

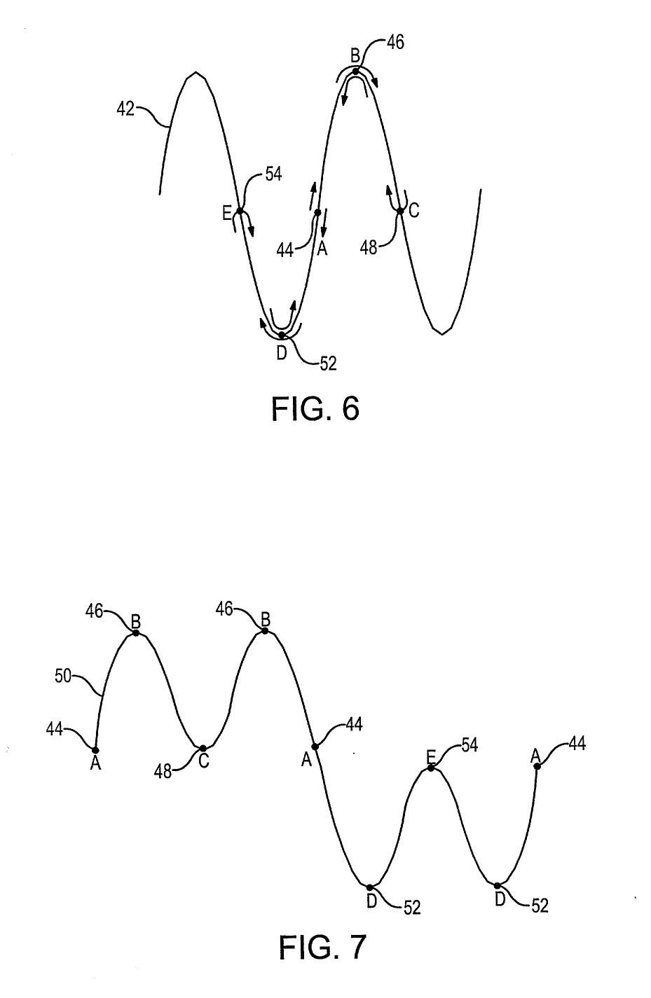

As the jitter is increased to levels in excess of 0.5 UIpp, an interesting effect occurs. Initially, it might be concluded that the process of quantifying jitter using an oscilloscope 10 is problematic beyond the level of 0.5 UIpp, since the amplitude of the signal for a 45 degree phase point is identical to what may be seen for a 135 degree deviation. However, these two conditions never occur simultaneously. To reach the 135 degree point, the signal must pass through 45 degrees to 90 degrees and then to 135 degrees. Thus, there is a specific trajectory that is mapped. The process of mapping the trajectory will be described with reference to FIGS. 6 and 7. These figures show the “walking” of the sampling points as a result of jitter. In FIG. 6, a 500 MHz signal 42 is modulated with 1 UIpp of jitter. Assuming that the signal begins with no phase deviation, samples are taken at the zero crossing Point A 44. Then, as the jitter begins to shorten subsequent periods of the signal 42, samples are taken at later and later phase points. As the jitter reaches 0.25 UIpp (90 degrees) deviation, samples are taken at Point B 46. FIG. 7 shows the jitter waveform 50 that is displayed on the oscilloscope, with the initial trajectory from the no jitter deviation Point A 44 to the 90 degree deviation at Point B.

When the jitter reaches 0.5 UIpp deviation (180 degrees) as its maximum phase deviation from nominal, samples are taken at Point C 48. As best seen in FIG. 7, the jitter “retreats” from this maximum, so that the trajectory retraces back to Point B 46 and then to Point A 44. Upon reaching zero crossing Point A the second time, the jitter causes the period of the signal 42 to begin to extend in time. Thus, the jitter waveform 50 of FIG. 7 follows a path from the second zero crossing at Point A to Point D 52 and then to Point E 54. Upon reaching Point E, a second reversal occurs and the trajectory is retraced from Point E 54 to Point D 52 and then to Point A 44. The distinct signature of the 1 UIpp jitter level is shown by the waveform 50 in FIG. 7. It is important to note that the timebases for FIGS. 6 and 7 are different. The timebase for FIG. 6 is on the order of the carrier period (2 nanoseconds, if the carrier signal 42 has a frequency of 500 MHz), while the timebase for FIG. 7 is on the order of a modulation period (2 microseconds, if the modulating frequency is 500 KHz).

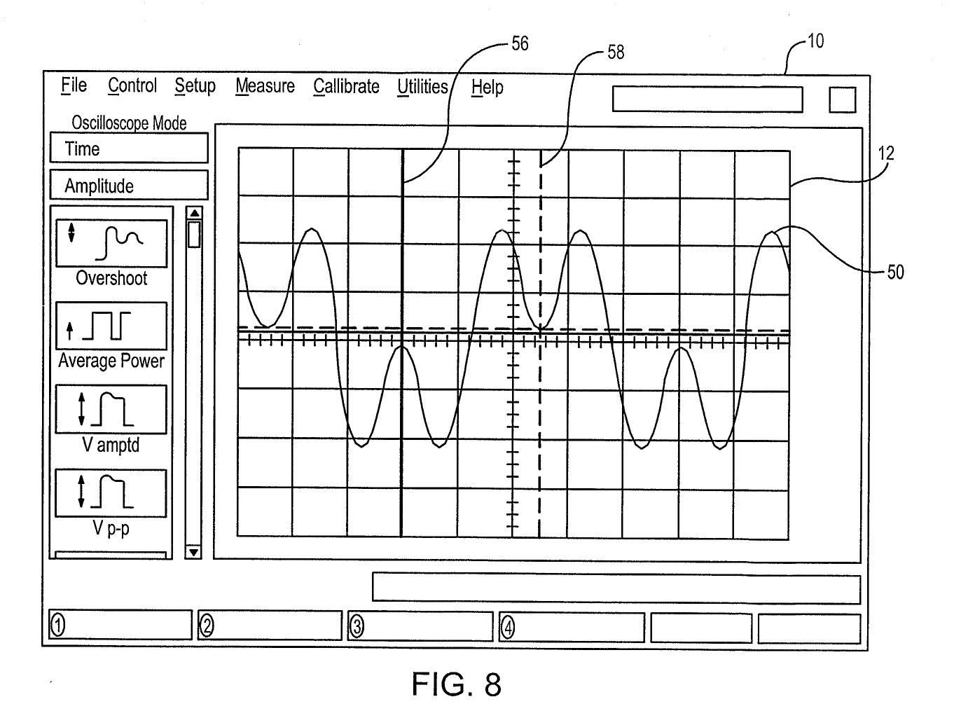

FIG. 8 shows a greater portion of a jitter waveform 50 for the 1 UIpp jitter level imposed on a 500 MHz carrier signal. As can be seen, the jitter waveform 50 follows the pattern that was described with reference to FIGS. 6 and 7. The trajectory continues to repeat at the rate of the jitter signal. The critical points to determine are the positions at which the trajectory reaches extremes, since these positions are indicative of the magnitude of the jitter. In FIG. 8, two successive periods at which the trajectory reverses direction are identified by oscilloscope markers 56 and 58. The time between the two extremes is half of a jitter cycle (1 microsecond). The time for a full jitter cycle is the time between similar phase reversals, such as adjacent phase reversals observed near the third and eighth grids from the left edge of the display screen 12. The time for the full jitter cycle is equal to the period of the jitter. In all cases except the N.5 UIpp cases (where N is a positive integer), the absolute maximum and minimum points are indicators of where the jitter simply walks through the +90 degree or −90 degree phase points of the carrier signal.

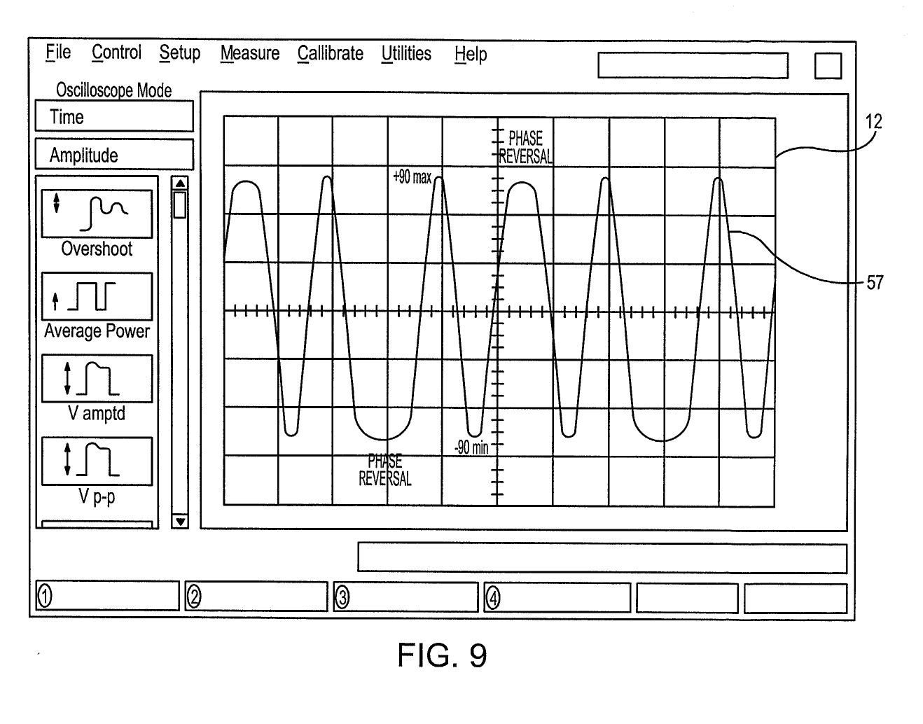

The same analysis applies to a 1.5 UIpp jitter level. Using FIG. 7, the jitter will walk 270 degrees first ahead and then behind the no phase deviation starting Point A 44. Thus, the phase reversals occur at the carrier signal maximum/minimum points. This is similar to what occurred for the 0.5 UIpp jitter level in that the extremes are at +/−90 degree points. However, the two cases are distinguishable, since the trajectory must pass through a carrier maximum/minimum pair prior to phase reversal extremes for 1.5 UIpp, whereas this does not occur for the 0.5 UIpp jitter. As can be seen by comparing the jitter signal trace 40 of FIG. 5, which is acquired in sampling the carrier signal having a 0.5 UIpp jitter level, with the 1.5 UIpp jitter signal trace 57 in FIG. 9, the signature for 1.5 UIpp jitter is distinguishable.

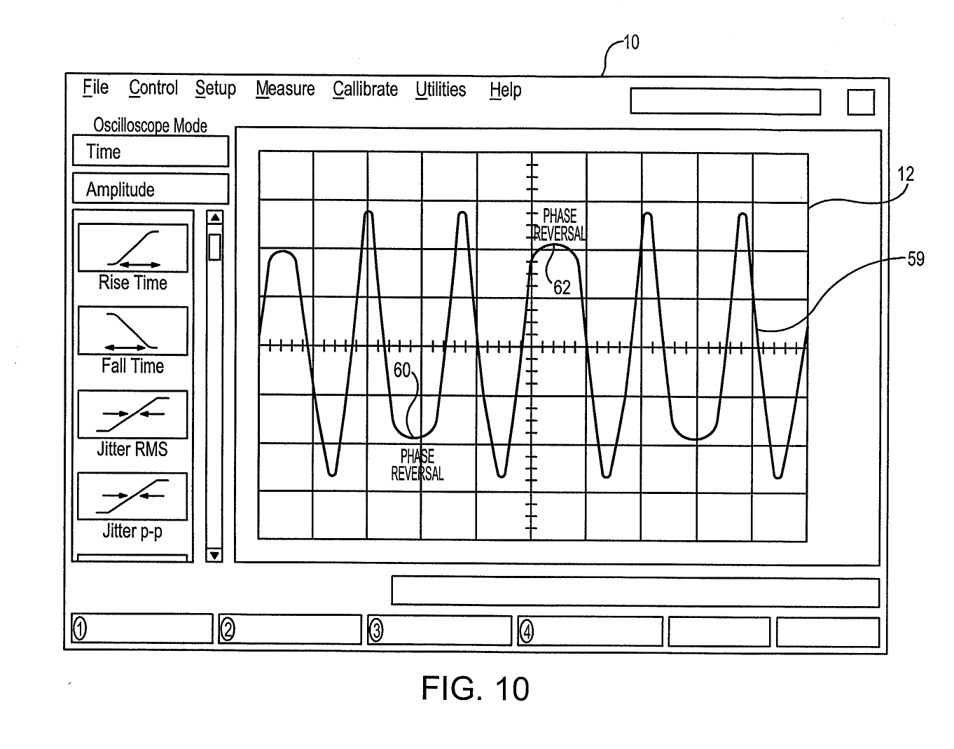

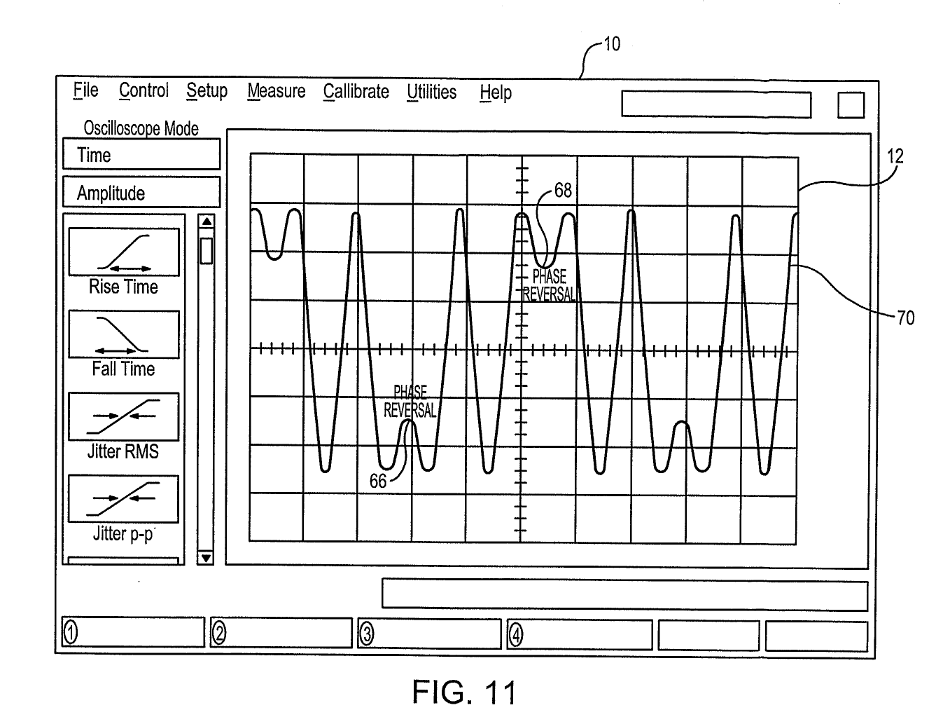

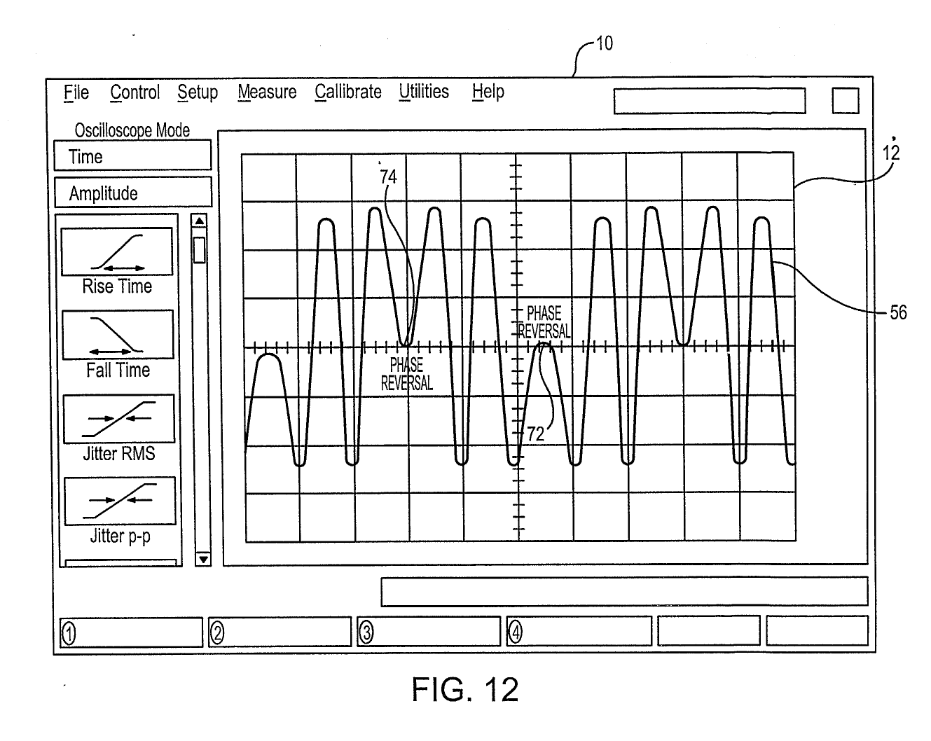

In FIG. 10, a waveform 59 is shown on the display screen 12 of the oscilloscope 10 for a 1.25 UIpp jitter level. The waveform includes adjacent phase reversals 60 and 62 that are separated by 450 degrees. Similarly, the jitter waveform 64 of FIG. 11 has adjacent phase reversal extremes 66 and 68 that are spaced apart by approximately 630 degrees, thereby indicating a 1.75 UIpp jitter level. In FIG. 12, a displayed waveform 70 includes successive phase reversals 72 and 74 and two full cycles between the phase reversal extremes, indicating a 2.0 UIpp jitter level.

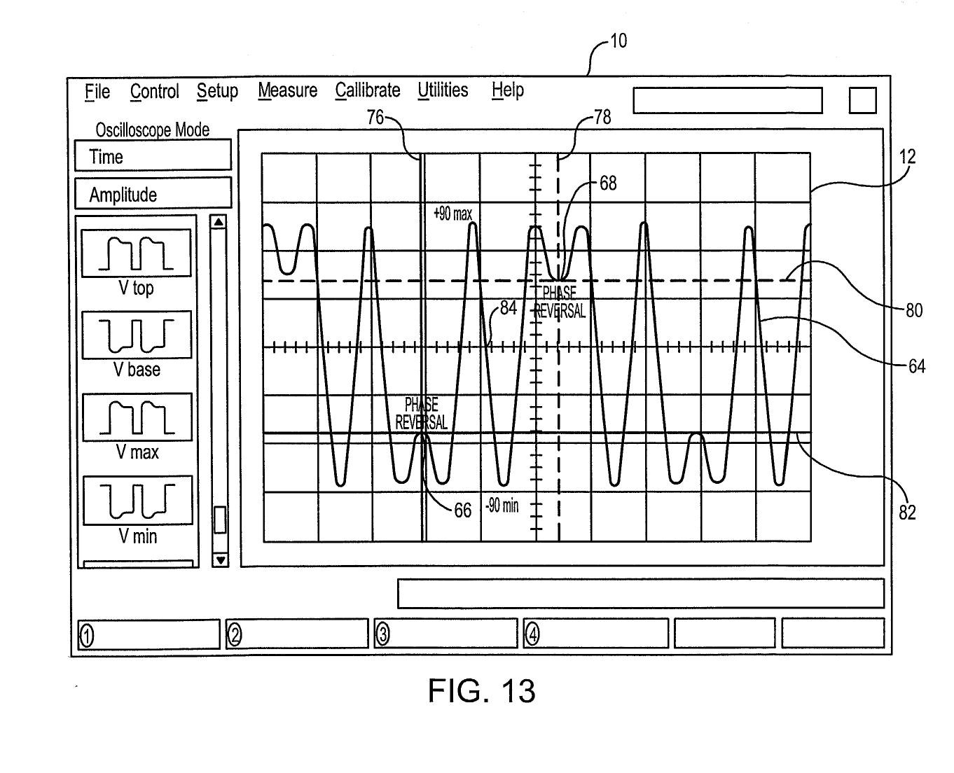

A general algorithm for determining jitter level will be described with reference to the 1.75 UIpp waveform 64 of FIG. 13 (which was also shown in FIG. 11). As a first step, adjacent phase reversal extremes are located. Four such extremes are included along the waveform of FIG. 13, but the center two extremes 66 and 68 are selected and are identified on the display screen 12 of the oscilloscope 10 by a pair of vertical markers 76 and 78. Horizontal oscilloscope markers 80 and 82 are used to identify the peak positions of the phase reversals 66 and 68.

A “no jitter starting point” 84 lies on the waveform 64 at a time exactly halfway between the two phase reversal extremes 66 and 68. From the start point 84, there are 270 degrees of deviation to the last 90 degree maximum that is prior to the second phase reversal extreme 68. The remaining phase to the extreme 68 is determined by performing an inverse cosine of the normalized amplitude of the signal at the phase reversal extreme. Thus,

$$\begin{matrix}Peak jitter ( deg ) = 270 + Arccos ( V ext - ( Vmax + Vmin ) / 2 ) / \\ ( Vmax - ( Vmax + Vmin ) / 2 ) \\ = 270 + Arccos ( 114 - ( 178 - 189 ) / 2 ) / \\ ( 178 - ( 178 - 189 ) / 2 ) \\ = 270 + Arccos ( 0.65 ) \\ = 319\end{matrix}$$

The jitter trajectory in the reverse direction from the starting point 84 should yield approximately the same level of deviation, but the signal levels are different, with

$$\begin{matrix}Peak jitter ( deg ) = 270 - Arccos ( V ext - ( Vmax + Vmin ) / 2 ) / \\ ( Vmin - ( Vmax + Vmin ) / 2 ) \\ = - 270 - Arccos ( - 114 - ( 178 - 189 ) / 2 ) / \\ ( - 189 - ( 178 - 189 ) / 2 ) \\ = - 270 - Arccos ( 0.74 ) \\ = - 312\end{matrix}$$

The total jitter is determined by subtracting the reverse extreme calculation (−312) from the forward extreme calculation (319) to yield 631 degrees. This calculation translates well to the known jitter level of 1.75 UIpp.

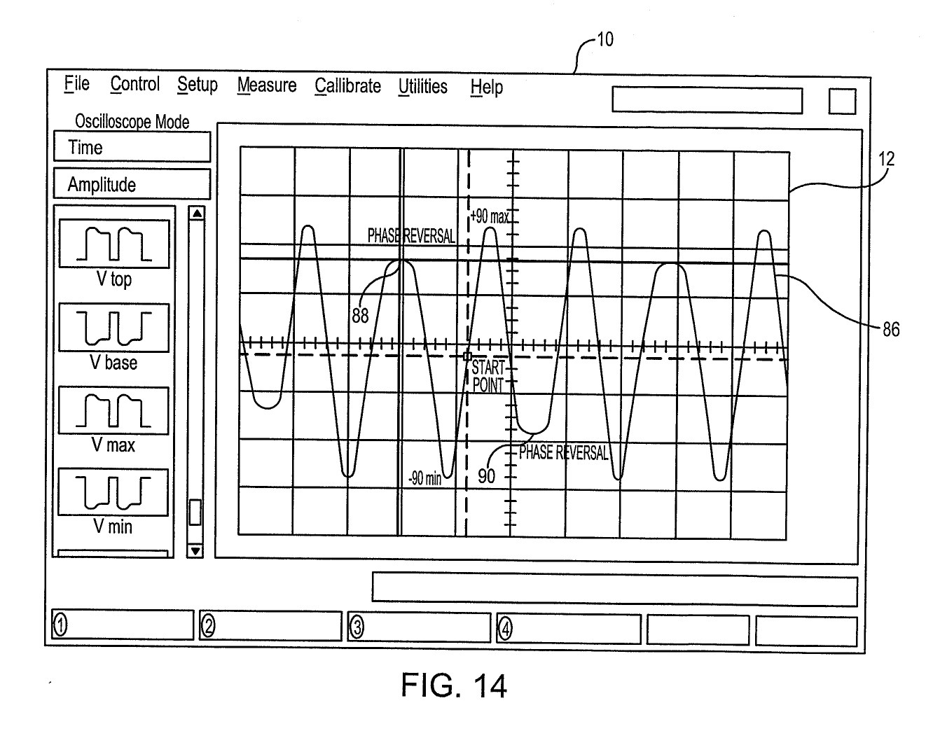

The general algorithm will also be applied to the 1.25 UIpp waveform 86 of FIG. 14. First, the phase reversal extremes 88 and 90 are identified. The mid point between the two extremes is the start point. From this start point to the last 90 degree maximum between the two extremes is 90 degrees. In the reverse direction, the phase to the 90 degree minimum is −90 degrees. Then,

(Vmax is 167, Vmin is −174, Vphase extreme1 is −102, Vphase extreme2 is 120)

$$\begin{matrix}Peak jitter ( deg ) = 90 + Arccos ( V ext1 - ( Vmax + Vmin ) / 2 ) / \\ ( Vmax - ( Vmax + Vmin ) / 2 ) \\ = 90 + Arccos ( - 102 - ( 167 - 174 ) / 2 ) / \\ ( 167 - ( 167 - 174 ) / 2 ) \\ = 90 + Arccos ( - 0.56 ) \\ = 215\end{matrix}$$

The jitter trajectory in the reverse direction yields

$$\begin{matrix}Peak jitter ( deg ) = - 90 - Arccos ( V ext2 - ( Vmax + Vmin ) / 2 ) / \\ ( Vmin - ( Vmax + Vmin ) / 2 ) \\ = - 90 - Arccos ( 120 - ( 167 - 174 ) / 2 ) / \\ ( - 174 - ( 167 - 174 ) / 2 ) \\ = - 90 - Arccos ( - 0.724 ) \\ = - 226\end{matrix}$$

The total calculated jitter is the forward extreme calculation (215) minus the reverse extreme calculation (−226), or 441 degrees. This translates to 1.23 UIpp, which is in satisfactory agreement with the known jitter level of 1.25 UIpp.

In some cases, significant averaging is involved in obtaining a desired jitter signal. In the test environment that was described above, it is believed that the higher degree of averaging was due to the phase incoherence between the source of the jitter and the source of the carrier signal. To acquire the jitter extremes to be displayed symmetrically required some adjustment of the trigger level. However, it is likely that the adjustments were not essential to the determination of the jitter level. In fact, this may be useful in locating the phase reversal extremes that exist near the relevant 90 degree points, where the signal flattens and renders it more difficult to obtain precision amplitude values. Adjusting the trigger levels slides the extremes along the carrier. This is particularly useful when the jitter identification approach is applied to data signals, where the flat regions are significantly larger than is typical of clock signals. As an optional feature, signal processing techniques are used to reduce the adverse effects of noise within the signals.

What is claimed is:

1. A method of identifying jitter in a signal of interest comprising the steps of:
connecting an oscilloscope to receive said signal of interest;
repetitively sampling said signal of interest at a generally fixed rate, thereby providing a sequence of oscilloscope samples; and
displaying said sequence of oscilloscope samples as a representation of said jitter.

2. The method of claim 1 wherein said step of repetitively sampling includes setting the timing of events such that said sampling repeatedly occurs at a specific phase point of said signal of interest, if said signal of interest is free of said jitter.

3. The method of claim 2 wherein said step of connecting said oscilloscope includes coupling an input of said oscilloscope to a source of a clock signal having a fixed target frequency, said clock signal being said signal of interest, and wherein said step of setting said timing includes configuring said oscilloscope to acquire said oscilloscope samples at a target phase point of successive pulses of a desired waveform maintained at said fixed target frequency.

4. The method of claim 1 wherein said step of displaying includes generating a waveform having characteristics that correspond to consistent characteristics of said jitter.

5. The method of claim 4 wherein said step of generating includes forming said waveform as a function of phase deviation in said signal of interest as detected during said sampling.

6. The method of claim 5 further comprising a step of quantifying a level of said jitter in said signal of interest on a basis of said waveform.

7. The method of claim 6 wherein said step of quantifying includes calculating a total of the degrees of phase deviation of said waveform from a first position of said waveform to a next corresponding position of said waveform.

8. The method of claim 7 wherein said step of calculating includes determining said total of said degrees of phase deviation for a portion of said waveform between two successive phase reversal extremes, said phase reversal extremes being said first position and said next corresponding position of said waveform.

9. A method of identifying signal jitter comprising the steps of:
coupling an input of a waveform-display device to a source of a signal intended to have a particular frequency pattern;
operating said waveform-display device to sample said signal at a frequency that is based on said particular frequency pattern, thereby acquiring data samples; and
generating a waveform from said data samples such that said waveform is indicative of time-based directions of significant instants of said signal from anticipated timing of said instants given said particular frequency pattern.

10. The method of claim 9 wherein said step of coupling said input includes receiving said signal from said source as a sinusoidal signal having a generally fixed target frequency, said target frequency being said particular frequency pattern.

11. The method of claim 9 wherein said step of coupling said input includes receiving said signal from a source of user data.

12. The method of claim 9 wherein said step of coupling said input includes connecting an oscilloscope to a generator of a clock signal, said oscilloscope being said waveform-display device and said generator being said source.

13. The method of claim 9 further comprising a step of determining a level of said signal jitter by analyzing said time-based deviations.

14. The method of claim 13 wherein said step of determining said level of signal jitter includes calculating degrees of said time-based deviations within a specific portion of said waveform, where said specific portion is bordered by corresponding significant instances of said waveform.

15. The method of claim 14 wherein said step of determining said level includes identifying phase reversal extremes in said waveform, said phase reversal extremes being said significant instances of said waveform.

16. A system of identifying signal jitter comprising:
a source of a signal intended to have a particular frequency pattern; and
an oscilloscope having an input connected to said source to receive said signal, said oscilloscope being set to generate and display a jitter waveform indicative of phase deviations of said signal from a signal which maintains said particular frequency pattern.

17. The system of claim 16 wherein said source generates a sinusoidal signal having a substantially fixed frequency.

18. The system of claim 17 wherein said oscilloscope is configured to repeatedly sample said sinusoidal signal at a target phase position when said source is maintained at said particular frequency.

19. The system of claim 18 wherein said oscilloscope is set to display multiple periods of said jitter waveform and is set such that phase reversals are identifiable along said jitter waveform.

20. The system of claim 16 wherein said source is a source of user data.
